(19) United States
(12) Patent Application Publication
(10) Pub. No.: US 2012/0114896 A1
(43) Pub. Date: May 10, 2012

(54) METHOD FOR FABRICATING CORE OF VACUUM INSULATION PANEL, CORE OF VACUUM INSULATION PANEL, AND VACUUM INSULATION PANEL HAVING THE SAME

(75) Inventors: Dongju Jung, Gyeongsangnam-Do (KR); Ilseob Yoon, Gyeongsangnam-Do (KR); Minkyu Hwang, Gyeongsangnam-Do (KR); Jinwoo Shim, Gyeongsangnam-Do (KR); Kyungdo Kim, Gyeongsangnam-Do (KR); Youngbae Kim, Gyeongsangnam-Do (KR)

(73) Assignee: LG Electronics Inc., Seoul (KR)

(21) Appl. No.: 13/383,398

(22) PCT Filed: Aug. 6, 2010
(86) PCT No.: PCT/KR2010/005174

§ 371 Date: Jan. 10, 2012

(30) Foreign Application Priority Data
Aug. 7, 2009 (KR) 10-2009-0072995

(51) Int. Cl. F16L 59/065; B27N 3/00

(52) U.S. Cl. 428/69; 156/62.6

(57) ABSTRACT

Disclosed are a method for fabricating a core of a vacuum insulation panel, a core of a vacuum insulation panel, and a vacuum insulation panel having the core. The core is positioned at an inner side of an envelope of a vacuum insulation member, which is formed by bonding synthetic resin material fibers through thermal bonding.

### TECHNICAL FIELD

The present invention relates to a method for fabricating a core of a vacuum insulation panel, a core of a vacuum insulation panel, and a vacuum insulation panel having the core.

### BACKGROUND ART

In general, a vacuum insulation panel is a sort of insulator decompresses an internal space into a vacuum state to thus use the characteristics of low thermal conductivity of vacuum. The vacuum insulation member may be implemented in the form of a panel having a certain thickness, which is generally called a vacuum insulation panel.

The vacuum insulation panel may be configured to include an envelope forming a certain space therein and a core accommodated at an inner side of the envelope and supporting such that the envelope to maintain the certain space. In addition, a getter for absorbing an infiltration gas introduced into the interior of the envelope or a leakage gas generated from the core material may be provided at the inner side of the envelope.

The envelope (e.g., a film), serving to maintain an internal vacuum degree of the vacuum insulation member at a certain level, is formed of a film formed by laminating multi-layered polymers and aluminum, or the like.

The core is fabricated by preprocessing glass fiber, glass wool, or silica core, and the like to have hardness of a certain degree and a desired size.

The getter is a sort of aspirator or an absorbent for absorbing gas and/or moisture which is present at the inner side of the envelope or newly introduced.

To be used as a core of a vacuum insulation panel, the core made from glass fiber or glass wool must undergo the foregoing preprocessing process. The reason is because, the glass fiber and glass wool has such a form of a sort of fiber, so if they are used as it is, they can be easily deformed by an external force or the textiles are shoved to each other, failing to maintain its external form. Thus, in the case of using glass fiber or glass wool, glass fiber or glass wool must be subjected to a compression process such as needling, and in order to prevent the material (the textures) from being shoved therein, an organic or inorganic binder is used.

### DISCLOSURE OF INVENTION

### Technical Problem

However, the organic or inorganic binder causes the performance of the vacuum insulation panel to be unstable. Namely, when the vacuum insulation panel is used, a gas of a certain component is leaked out of the organic or inorganic binder and such a gas leakage lowers the internal vacuum degree of the vacuum insulation panel, degrading the insulation performance. Thus, in order to prevent this phenomenon, a high-priced getter must be used to increase the fabrication unit cost.

In addition, when glass fiber or glass wool is intended to be discarded, glass fiber or glass wool is not recycled or can be hardly incinerated, and a great deal of dust is created to be stirred up in fabricating the vacuum insulation member.

### Solution to Problem

Therefore, in order to address the above matters, the various features described herein have been conceived.

An aspect of the present invention provides a vacuum insulation panel capable of minimizing the amount of a leakage gas generated from a core material in its use.

According to an aspect of the present invention, there is provided a core positioned at an inner side of an envelope of a vacuum insulation member, which is formed by bonding synthetic resin material fibers through thermal bonding (or a heat fusion).

In the above aspect, the core of the vacuum insulation member may be fabricated with synthetic resin material fiber, not the existing glass fiber or glass wool, and the fibers are heated at the temperature of the melting point or the like so as to be thermally bonded. Through this, the form of the core can be maintained without having to use a binder, and as a result, degradation of an insulation performance caused by a gas leakage from an organic or in organic binder can be prevented.

Here, the synthetic resin material fiber may be a short staple.

In addition, a coating material having a lower melting point than that of the synthetic resin fiber may be coated on and thermally bonded to at least a portion of the synthetic resin fiber. In this case, a heating temperature of the thermal bonding may be lower than the melting point of the synthetic resin fiber and higher than the melting point of the coating material, so that only the outer coating material can be molten to be thermally bonded while the form of the fiber is maintained as it is.

Here, the synthetic resin fiber may be a polyethylene (PET) resin, and the coating material may be also a polyethylene resin. In this case, however, as described above, the coating material must have a lower melting point than that of the synthetic resin fiber.

According to another aspect of the present invention, there is provided a vacuum insulation member including: an envelope; a core encapsulated by the envelope; and a getter positioned at the core, wherein the core is one of the foregoing cores.

According to another aspect of the present invention, there is provided a method for fabricating a core of a vacuum insulation member, including: charging a polyethylene (PET) resin fiber at an inner side of a frame of a certain form; and heating the charged PET resin fiber at a temperature higher than a melting point to thermally bond it.

According to another aspect of the present invention, there is provided a method for fabricating a core of a vacuum insulation member, including: mixing a polyethylene resin fiber and a polyethylene resin fiber coated with a coating material having a lower melting point than that of the polyethylene resin fiber on an outer surface thereof; charging the mixed polyethylene resin fibers at an inner side of a frame of a certain form; and heating the charged polyethylene resin fiber mixture at a temperature higher than the melting point of the coating material but lower than the melting point of the polyethylene resin fiber to thermally bond them.

The polyethylene resin fiber may be a short staple.

The method may further include: needling the thermally bonded core.

According to exemplary embodiments of the present invention, the form of the core can be maintained without having to use an organic or inorganic binder, so degradation of an insulation performance caused by a leakage gas from the binder can be prevented.

The foregoing and other objects, features, aspects and advantages of the present invention will become more apparent from the following detailed description of the present invention when taken in conjunction with the accompanying drawings.

### BRIEF DESCRIPTION OF DRAWINGS

FIG. 1 is a sectional view showing an internal structure of a vacuum insulation member according to an exemplary embodiment of the present invention;

FIG. 2 is an enlarged sectional view showing a portion in FIG. 1 according to the exemplary embodiment of the present invention;

FIG. 3 is a perspective view showing the structure of coating yarn used in FIGS. 1; and

FIG. 4 is a flow chart illustrating a process of fabricating the vacuum insulation member illustrated in FIG. 1.

### BEST MODE FOR CARRYING OUT THE INVENTION

Exemplary embodiments of the present invention will now be described in detail with reference to the accompanying drawings.

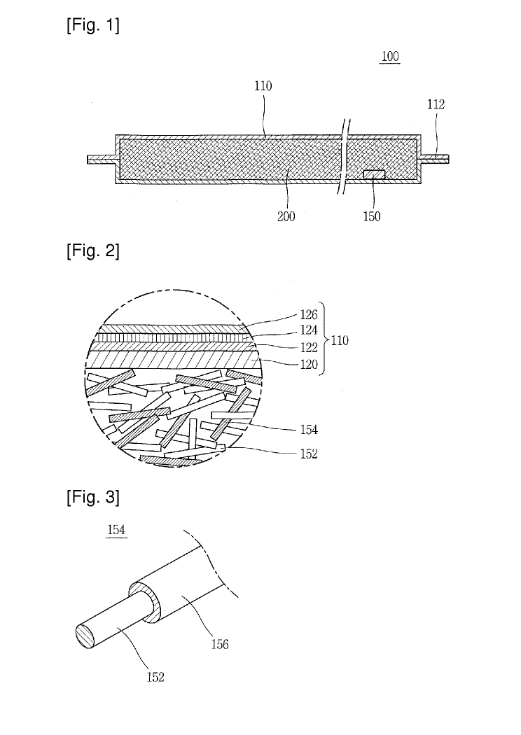

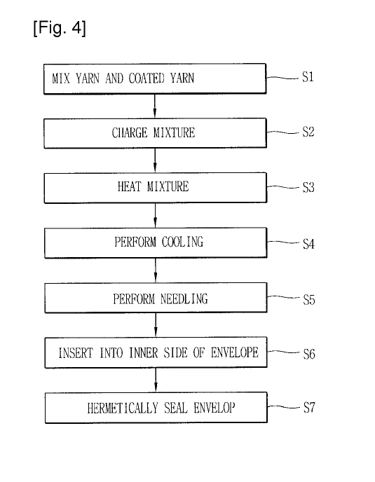

FIG. 1 is sectional view showing an internal structure of a vacuum insulation member according to an exemplary embodiment of the present invention, and FIG. 2 is an enlarged sectional view showing a portion in FIG. 1 according to the exemplary embodiment of the present invention.

As shown in FIGS. 1 and 2, a vacuum insulation member 100 may be configured to include an envelope 110 having gas barrier characteristics and forming a certain decompressed space therein, a core 150 disposed at an inner side of the envelope and supporting the envelope; and a getter 200 provided at the inner side of the envelope. Here, the decompressed space may be a space in which internal pressure is decompressed to be lower than atmospheric pressure.

The envelope 110 is formed not to allow air to be introduced therein or has gas barrier characteristics in order to form the decompressed space therewithin. In addition, a junction part 112 may be formed at one side of the envelope after the core 150 is accommodated. Namely, the envelope is provided in the form that one side thereof is open during a fabrication process, and a completed core is pushed in through the open side, which is then encapsulated to hermetically seal the open side. The hermetically sealed side corresponds to the junction part 112.

The envelope includes a plurality laminated film layers. FIG. 2 shows such film layers. The lowermost layer of the plurality of film layers is formed as a heat blocking layer 120, on which an aluminum foil 122, a protection layer 124, and an aluminum foil film 126 are sequentially laminated.

The getter 200 for absorbing a gas component remaining at the inner side of the envelope or a gas component introduced from the exterior to the interior of the envelope. In general, getters having various components are used to absorb various types of gas such as an infiltration gas infiltrating from the exterior or a leakage gas generated from the internal core or the like, but in the present exemplary embodiment, there is no gas leaked from the core or a very little amount of gas is leaked, so moisture is a critical factor affecting the insulation performance. Thus, it would be sufficient for the getter 200 to include CaO or zeolite such that mainly moisture can be absorbed. Here, as illustrated, the getter 200 has the shape of a certain block or a rectangular shape, but according to circumstances, the getter 200 may be configured to be coated on an inner surface of the envelope or on the surface of the core.

Meanwhile, the core 150 is provided at the inner side of the envelope 110 in order to support the envelope 110 to form and maintain a certain decompressed space. In the present exemplary embodiment, the core 150 is formed by thermally bonded polyethylene resin short staples. In detail, the polyethylene resin short staples constituting the core 150 may be divided into two types: one of which is the polyethylene resin short staple itself and the other is a polyethylene resin coated short staple formed by coating an outer surface of the polyethylene resin short staple with a coating material 156. In the following description, the polyethylene resin short staple will be referred to as ‘yarn’ and the coated short staple will be referred to as ‘coated yarn’ for the sake of explanation.

Here, the coating material of the coated yarn 154 is also made of a polyethylene resin but has a melting point lower than that of the polyethylene resin constituting the yarn 152. Roughly, the yarn has a melting point of about 150 C, and the coating material has a melting point of about 110 C. The yarn 152 and the coated yarn 154 are mixed at a certain ratio, e.g., at a ratio of 1:1 and then heated so as to be thermally bonded. In this case, the heating temperature is higher than 110 C, the melting point of the coating material, but lower than 150 C, the melting point of the yarn 152.

Through the heating operation, the yarn 152 maintains in its original form, while the coated yarn 154 is molten so as to be bonded with the yarn 152 or another coated yarn 154, and the bonded state of them is maintained through cooling. Thus, the core 150 is made of only the polyethylene resin without having to use a binder.

The polyethylene resin is a raw material harmless to the human body, which thus can be used as a food container, so it does not do harm to an operator although the operator directly touches the polyethylene resin during a fabrication process. Also, dust is not generated during the operation of fabricating the vacuum insulation member. In addition, compared with the material such as glass fiber or glass wool, the polyethylene resin has a weight of about 60 percent level, so it can be easily handled. Moreover, the polyethylene resin reduces an allotment based on the regulations of waste electrical and electronic equipment (WEEE) by the reduced weight. Furthermore, because the cost of the material itself is lower than glass fiber, the cost of the vacuum insulation member can be also lowered.

Meanwhile, in the present exemplary embodiment, the case in which the yarn and the coated yarn are mixed and then thermally bonded is described, but the present invention is not necessarily limited thereto, and only yarn may be thermally bonded. Namely, yarn short staples having a melting point of about 150 C are heated at a temperature of about 150 C, the yarn is molten, starting from its surface, so the yarn may be heated for a time during which the yarn is not completely molten, and then cooled to allow the respective yarn to be thermally bonded.

The fabrication process according to the present exemplary embodiment will now be described.

First, the yarn and the coated yarn are mixed in a certain ratio, e.g., in the ratio of 1:1 (S1), which are than charged at the inner side of the frame or a mold having a space fitting the form of the core (S2).

Next, the mixture is heated at a temperature ranging from 110 C to 150 C to allow the coated yarn to be molten and bonded to neighbor yarn or coated yarn (S3). When the coating yarn is molten to a degree, heating is stopped and the coated yarn is cooled (S4). Thereafter, the coated yarn is compressed to have a density of a desired degree through a needling process to form a core (S5), and the core is then inserted into the inner side of the envelope (S6).

Here, the envelope must be tightly attached to the core, so in the process of inputting the core, the yarn or the coated yarn that may be protruded from the surface of the core is rubbed with an inner surface of the envelope. In case of the related art glass fiber or glass wool, the material itself has a high hardness to do damage to the inner surface of the envelope during frictional state, causing a high defective rate. Thus, the processing inputting the core to the inner side of the envelope without causing a defect must be manually performed carefully, degrading the productivity. Also, even after the completion, when an external force is applied to the surface of the vacuum insulation material, an end portion of the protruded fiber is likely to damage the envelope.

However, because the polyethylene resin has hardness of 1/30 of glass fiber, it can be bent when it is rubbed, without causing damage to the inner surface of the envelope.

With the core inserted into the interior of the envelope, the envelope is hermetically sealed under a vacuum atmosphere (S7), thus completing the fabrication of the vacuum insulation member. Here, the needling process (step S5) may be omitted by performing a thermal bonding process in a state that the yarn and the coated yarn are compressed.

In addition, when only the yarn, not a mixture, is in use, the foregoing mixing process (i.e., step S1) may be omitted.

As the present invention may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

1. A core positioned at an inner side of an envelope of a vacuum insulation member, which is formed by bonding synthetic resin material fibers through thermal bonding.

2. The core of claim 1, wherein the synthetic resin material fiber is a short staple.

3. The core of claim 2, wherein a coating material having a lower melting point than that of the synthetic resin fiber is coated on and thermally bonded to at least a portion of the synthetic resin fiber.

4. The core of claim 3, wherein the synthetic resin fiber is a polyethylene (PET) resin.

5. The core of claim 4, wherein the coating material is a polyethylene resin.

6. A vacuum insulation member comprising:
an envelope;
a core encapsulated by the envelope; and
a getter positioned at the core,
wherein the core is one of the cores described in claim 1.

7. A method for fabricating a core of a vacuum insulation member, the method comprising:
charging a polyethylene (PET) resin fiber at an inner side of a frame of a certain form; and
heating the charged PET resin fiber at a temperature higher than a melting point to thermally bond it.

8. The method of claim 7, wherein the polyethylene resin fiber is a short staple.

9. The method of claim 7, further comprising:
needling the thermally bonded core.

10. A method for fabricating a core of a vacuum insulation member, the method comprising:
mixing a polyethylene resin fiber and a polyethylene resin fiber coated with a coating material having a lower melting point than that of the polyethylene resin fiber on an outer surface thereof;
charging the mixed polyethylene resin fibers at an inner side of a frame of a certain form; and
heating the charged polyethylene resin fiber mixture at a temperature higher than the melting point of the coating material but lower than the melting point of the polyethylene resin fiber to thermally bond them.

11. The method of claim 10, wherein the polyethylene resin fiber is a short staple.

12. The method of claim 10, further comprising:
needling the thermally bonded core.

13. A vacuum insulation member comprising:
an envelope;
a core encapsulated by the envelope; and
a getter positioned at the core,
wherein the core is one of the cores described in claim 2.

14. A vacuum insulation member comprising:
an envelope;
a core encapsulated by the envelope; and
a getter positioned at the core,
wherein the core is one of the cores described in claim 3.

15. A vacuum insulation member comprising:
an envelope;
a core encapsulated by the envelope; and
a getter positioned at the core,
wherein the core is one of the cores described in claim 4.

16. A vacuum insulation member comprising:
an envelope;
a core encapsulated by the envelope; and
a getter positioned at the core,
wherein the core is one of the cores described in claim 5.
